(19) United States
(12) Patent Application Publication
(10) Pub. No.: US 2013/0326900 A1
(43) Pub. Date: Dec. 12, 2013

(54) APPARATUS, METHODS AND SYSTEMS FOR RAPID DRYING OF LOOSE AND COMPACTED SAMPLES OF MATERIAL USING ELECTROMAGNETIC ENERGY

(71) Applicant: INSTROTEK, INC., Raleigh, NC (US)

(72) Inventors: Lawrence H. James, Raleigh, NC (US); Peter D. Muse, Durham, NC (US); Ali Regimand, Raleigh, NC (US); Dirk Steckmann, Cary, NC (US); Bilal Bajwa, Raleigh, NC (US)

(21) Appl. No.: 13/836,003

(22) Filed: Mar. 15, 2013

Related U.S. Application Data
(60) Provisional application No. 61/656,177, filed on Jun. 6, 2012.

(51) Int. Cl. F26B 3/30

(52) U.S. Cl. CPC F26B 3/30
USPC 34/266; 34/245

(57) ABSTRACT

A method for drying at least one sample of material includes: placing the at least one sample of material into an interior of a sealable chamber; sealing the chamber; applying a vacuum to the interior of the chamber; heating the at least one sample using electromagnetic energy while applying the vacuum to the interior of the chamber; electronically monitoring at least one condition in the interior of the chamber; and determining that the at least one sample is dry based on the at least one monitored condition.

### RELATED APPLICATIONS

This application claims priority from U.S. Provisional Application No. 61/656,177, filed Jun. 6, 2012, the disclosure of which is hereby incorporated herein in its entirety.

### BACKGROUND

In many applications, obtaining dry samples for testing is important. For example, to measure bulk specific gravity or density of compacted asphalt samples, it is important to have an accurate measure of dry weight (mass). Since the measurement of density is proportional to the weight of the sample, any water not removed by the drying process will inflate the indicated density measurement, potentially causing the test to provide an incorrect analysis of susceptibility of the material. For example, if density is used as a quality control indicator of the compacted asphalt material, then density measured using an unreliable drying process can lead to suspect results.

Drying asphalt or loose aggregate samples has conventionally followed two routes: 1) ambient-drying (e.g., by using forced air from a fan); or 2) oven-drying. Ambient-drying using a fan is often performed to prevent any change of the material that may be induced by heat during oven drying. This method, even though it is less accurate, is quicker than the conventional oven drying method. However, ambient-drying is most effective when water is on or near the surface of the sample. Water trapped in voids may not evaporate in the time frame of ambient air drying, which is usually about 2 to 4 hours.

Oven-drying may be performed at high temperatures, such as over 50° C. (122° F.), so as to raise the vapor pressure and possibly drive the trapped water out of the voids. However, such heating can potentially change the characteristics of the sample by driving off low temperature volatiles and can also potentially damage the integrity of the sample (especially if temperatures of above 60° C. or 140° F. are used for drying). In addition, water may still be trapped and may not evaporate in the time frame used in connection with oven drying. Typically, the sample is dried in the oven overnight and is simply deemed or assumed to be dry within this time frame. Alternatively, by a repetitive drying and weighing sequence it may be determined that no more water is being driven out from the sample.

More recently, vacuum-drying brought a major improvement to the industry in both time and consistency. Because of the reduced pressure, trapped vapor is forced out of the accessible pores allowing trapped water to evaporate quickly. This process has significantly reduced the drying time, with the usual drying time for field cores on the order of 15 minutes, an approximate 30-fold faster cycle over oven-drying. In addition, tests indicate that vacuum-drying pulls additional water out of samples that had previously been oven-dried at temperatures of less than 100° C.

Even though there is a remarkable increase in speed and consistency using vacuum-drying, the speed of drying can depend on the number of samples dried at one time and the rate of water removal from the samples. In some production environments, there is a desire to dry multiple (or large) samples at one time, while achieving equivalent drying speed, for example between 15-20 minutes. The drying speed depends on the total amount of water in the sample.

### SUMMARY

According to a first aspect, embodiments of the invention are directed to a method for drying at least one sample of material. The method includes: placing the at least one sample of material into an interior of a sealable chamber; sealing the chamber; applying a vacuum to the interior of the chamber; heating the at least one sample using electromagnetic energy while applying the vacuum to the interior of the chamber; electronically monitoring at least one condition in the interior of the chamber; and determining that the at least one sample is dry based on the at least one monitored condition.

In some embodiments the method includes heating the at least one sample using microwave energy and a waveguide so as electromagnetic waves cover all sides of a respective sample in the sealed chamber. In some embodiments, the heating is carried out to maintain the at least one sample and/or the interior of the chamber at a substantially constant temperature. The constant temperature may be about room temperature. In some embodiments, the heating is carried out by automatically adjusting the electromagnetic energy delivered or output to maintain the at least one sample and/or the interior of the chamber at a substantially constant temperature.

The method may include filtering moisture from air evacuated from the chamber during at least a portion of the applying the vacuum. The at least one sample of material may be at least one compacted asphalt sample. The at least one sample of material may be at least one loose asphalt mix or loose aggregate. The at least one sample of material may include a plurality of samples of material.

In some embodiments, monitoring the at least one condition comprises monitoring pressure of the sealed chamber. In some embodiments, heating is carried out using microwave energy, and monitoring the at least one condition comprises monitoring infrared radiation. Determining that the at least one sample is dry based on the at least one monitored condition may be based on a rise in the monitored infrared radiation and a substantially concurrent corresponding drop in the monitored pressure. In some embodiments, the method includes filtering the infrared radiation below a first predetermined wavelength. In some embodiments, the method includes filtering the infrared radiation below first and second predetermined wavelengths.

The method may include collecting residual water on a thermal energy element under a respective sample in the sealed chamber and evaporating the residual water during the heating step.

According to a second aspect, embodiments of the invention are directed to a system for drying at least one sample of material. The system includes: a sealable chamber including an interior sized and configured to house the at least one sample of material, the chamber including an outlet; a vacuum pump in fluid communication with the chamber to evacuate air from the interior of the chamber through the outlet of the chamber; an electromagnetic energy source in communication with the chamber; and at least one controller. The at least one controller is configured to: operate the vacuum pump and the electromagnetic energy source; start and stop a drying operation using the vacuum pump and the electromagnetic energy source; monitor pressure and infrared radiation in interior of the chamber; and determine that the at least one sample of material is dry based on the monitored pressure and infrared radiation.

The system may include a first valve positioned between the vacuum pump and the chamber and a second valve in fluid communication with the chamber and configured to introduce atmospheric air to the interior of the chamber when open, wherein the controller is configured to open and close the first and second valves. In some embodiments, during the drying operation: the vacuum pump is on; the first valve is open; the second valve is closed; and the electromagnetic energy source is operated to maintain the interior of the chamber at about room temperature. The system may include a lid for sealably closing the chamber during the drying operation, wherein the first valve is closed and the second valve is open after the drying operation to allow the lid to be removed and the at least one dry sample to be accessed. The system may include a moisture trap positioned between the vacuum pump and the chamber to filter moisture from the evacuated air during the drying operation. The system may include at least one evaporator plate positioned below the at least one sample and configured to provide thermal energy to evaporate residual water within the chamber during the drying operation.

In some embodiments, the system includes a pressure sensor configured to detect the pressure inside the chamber and an infrared radiation sensor configured to detect the infrared radiation inside the chamber. The infrared radiation sensor may include a filter for filtering the infrared radiation below a predetermined wavelength. The infrared radiation sensor may include a first filter for filtering the infrared radiation below a first predetermined wavelength and a second filter for filtering the infrared radiation below a second predetermined wavelength. The at least one controller may be configured to determine that the at least one sample of material is dry based on a drop in the monitored pressure and a substantially concurrent corresponding rise in the monitored infrared radiation.

According to a third aspect, embodiments of the invention are directed to a method for drying at least one sample of material. The method includes: placing the at least one sample of material into an interior of a sealable chamber; sealing the chamber; applying a vacuum to the interior of the chamber; heating the at least one sample using electromagnetic energy while applying the vacuum to the interior of the chamber; monitoring pressure and infrared radiation in the interior of the chamber over time; and determining that the at least one sample is dry based on an increase in the monitored infrared radiation and a substantially concurrent corresponding decrease in the monitored pressure.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIGS. 1A and 1B provide schematic illustrations with a side-by-side comparison of heating performed by an existing drying system (FIG. 1A) and a drying system according to embodiments of the present invention (FIG. 1B).

FIG. 2A is a side view of a drying system according to some embodiments of the present invention.

FIG. 2B is a top view of the drying system of FIG. 2A.

FIG. 3 is a sectional side view of a drying system according to some embodiments of the present invention.

FIG. 4 is a schematic sectional side view of a drying system according to some embodiments of the present invention.

FIGS. 5A and 5B are sectional side views of an exemplary drying system in a closed state (FIG. 5A) and an open state (FIG. 5B) according to some embodiments of the present invention.

FIG. 6 is a schematic illustration of an exemplary temperature sensing system including an infrared sensor according to some embodiments of the present invention.

FIG. 7 is a schematic illustration of the infrared sensor of FIG. 6 according to some embodiments of the present invention.

FIG. 8 is a graph illustrating specific radiation vs. wavelength at different temperatures as well as the transmittance of different infrared filters used in connection with the temperature sensing system of FIGS. 6 and 7.

FIG. 9 is a schematic illustration of a temperature sensing system according to some embodiments of the present invention.

FIG. 10 is a graph illustrating background infrared radiation (millivolts) vs. time (minutes) for a first experiment.

FIG. 11 is a graph illustrating chamber pressure (ton) vs. time (minutes) for the first experiment of FIG. 10.

FIG. 12 is a graph illustrating background infrared radiation (millivolts) vs. time (minutes) for a second experiment.

FIG. 13 is a graph illustrating chamber pressure (ton) vs. time (minutes) for the second experiment of FIG. 12.

FIG. 14 is a graph illustrating background infrared radiation (millivolts) vs. time (minutes) for a third experiment.

FIG. 15 is a graph illustrating chamber pressure (torr) vs. time (minutes) for the third experiment of FIG. 14.

FIG. 16 is a flow chart illustrating exemplary operations according to some embodiments.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the expression “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

As used herein, the term “about” used in connection with a recited (e.g., claimed) value means+/−10% or +/−20% of the claimed value in various embodiments.

As used herein, the terms “ambient temperature” and “room temperature” are used interchangeably and include temperatures between 60° F. and 90° F. and/or between 65° F. and 75° F. in various embodiments.

The present invention provides methods, apparatuses and systems for rapid drying of loose and compacted material samples. More specifically, the invention may be particularly suitable for use with material specimens which exhibit porosity or voids, such as samples of uncompacted, loose, or compacted bituminous mixtures, aggregates, and concrete specimens used in the structure, infrastructure, and/or underlayment of many roadways and other composite compacted materials.

Water will evaporate as long as the partial pressure of the water vapor is less than the vapor pressure at a specific temperature. The process of evaporation involves the escape of molecules of the substance from the surface into the surrounding atmosphere. If there is the same amount of atmospheric vapor recombining with the substance as that which escapes, then the substance is in dynamic equilibrium and no net evaporation takes place. This is the point at which the partial pressure of vapor in the atmosphere is equal to the vapor pressure of the substance. In addition, the atmospheric pressure contributes to slowing the rate of evaporation since molecules which escape the surface must diffuse through the atmosphere rather than rapidly moving away.

Applying a vacuum serves two purposes in this regard. First, it removes the ambient atmosphere so that the diffusion of the molecules proceeds much more rapidly. Second, it removes the vapor so that a dynamic equilibrium is not established.

However, during the vacuum process, as water evaporates, the liquid remaining loses energy and begins to cool. As it cools, the vapor pressure decreases and the rate of evaporation substantially decreases. In order to keep the evaporation rate high, heat can be applied and/or supplied to the water or to the substance in which the water is contained.

The process of drying a porous material that has been saturated with water in ambient atmospheric conditions encounters two difficulties. The first difficulty is that the water vapor must typically diffuse through the atmosphere. Water trapped inside a pocket within a pore will evaporate until the pressure of the vapor in its local surroundings is equal to the vapor pressure at that elevated temperature. In order for additional evaporation to take place, the water vapor must diffuse through a complex maze of channels at ambient pressure, which may be a slow process. The second difficulty is that there may be restrictions on the temperature at which the porous specimens may be elevated. This may be because of the possibility of changing the physical characteristics of the material.

With vacuum-drying, the vapor from the same water trapped in the same pocket will make its way out of the complex channels much more rapidly because there is no ambient atmosphere to work against. As long as the temperature of the water and porous media can be sustained, the evaporation proceeds rapidly.

Vacuum-drying systems typically employ a sealable chamber in which loose or compacted samples are placed. It will be appreciated from the above discussion that it is desirable to maintain the chamber at a controlled temperature during the vacuum process. In some existing systems, heat is applied from outside the chamber, thereby maintaining an elevated temperature while applying vacuum. In some other existing systems, a cyclical drying process takes place wherein heated air is periodically supplied to the chamber to maintain the controlled temperature. Exemplary vacuum-drying methods and systems are described in co-owned U.S. Pat. No. 8,225,526, the disclosure of which is incorporated herein in its entirety.

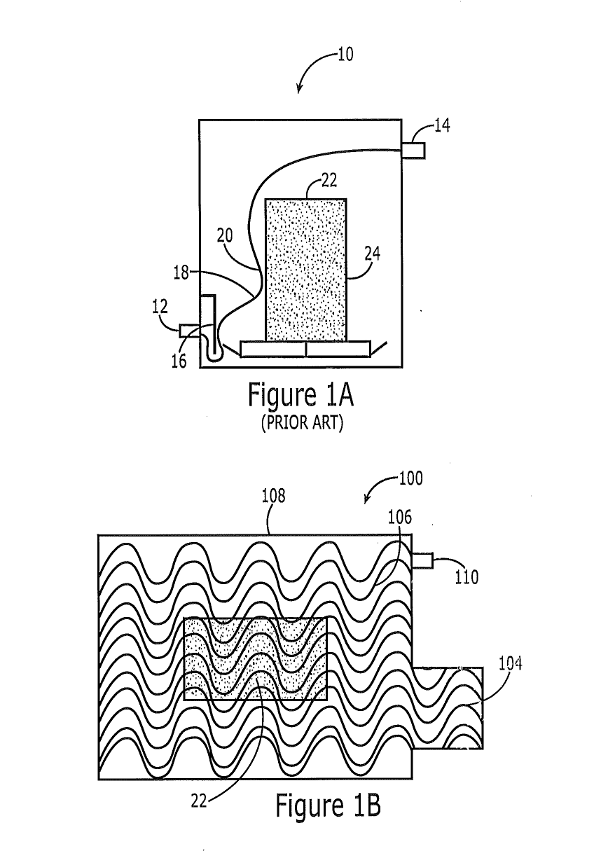

Generally stated, embodiments of the present invention employ electromagnetic energy to heat the specimen or sample chamber and/or one or more samples contained therein while vacuum is applied to the chamber. Electromagnetic energy produces heat that may be more uniformly applied around the sample compared with other heating methods. FIGS. 1A and 1B provide a side-by-side comparison of an existing system 10 employing heated air and a system 100 according to some embodiments of the invention employing electromagnetic energy. As noted above, in the existing system 10, a flow cycle is used to keep the sample from becoming excessively cool as moisture evaporates. As shown in FIG. 1A, during this cycle heated air enters orifice 12 and is pulled out from orifice 14. The heated air entering orifice 12 is dispersed using dispersion shield 16. However, due to incomplete dispersion, the heated air 18 can flow toward the closest side 20 of the asphalt sample 22. The heated air 18 impinges on the side 20 causing it to remain warm or at room temperature. The air is then drawn around asphalt sample 22 and out orifice 14. As such, an opposite side 24 of the asphalt sample 22 remains cool.

FIG. 1B shows the sample 22 in a system 100 according to some embodiments that employs electromagnetic energy (e.g., microwave electromagnetic energy) enclosed in a cavity designed to create standing waves for the microwave wavelength. In the illustrated embodiment, the microwaves originating from a wave guide 104 produce standing waves 106 inside a microwave cavity 108. The standing waves 106 can be distributed evenly about all sides of the sample 22. This produces uniform heating across the sample surface and efficient drying. It will be understood that one or more samples 22 may be placed in the cavity 108 in various orientations. It will also be understood that the heating may be provided by other forms of electromagnetic energy not limited to microwaves, such as infrared energy/radiation.

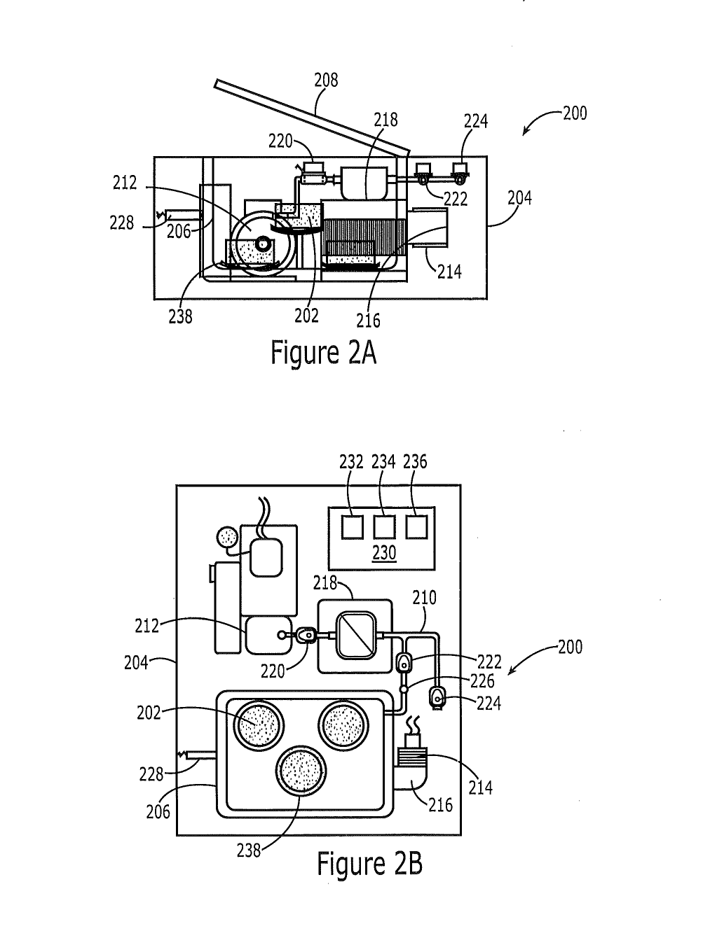

FIGS. 2A and 2B illustrate a drying system or unit 200 that uses microwave electromagnetic energy to dry asphalt/concrete samples 202 according to some embodiments. A front view of the unit 200 is shown in FIG. 2A and a top view of the unit 200 is shown in FIG. 2B. An enclosure or housing 204 encloses various components of the unit 200. As shown, a microwave cavity 206 forms a portion of the sample containment system. A lid 208 is provided to form an enclosable microwave cavity. The microwave cavity 206 also defines a vacuum chamber, henceforth simply referred to as the “cavity” or “chamber” 206. The cavity 206 is attached via tubing 210 to a vacuum pump 212 to allow a vacuum to be applied or introduced inside the cavity 206. Simultaneously, a variable power microwave generator 214 is attached to wave guide 216 to provide controllable and variable microwave power to the cavity 206.

A moisture trap 218 is placed between the cavity 206 and the vacuum pump 212 to trap moisture before it enters the vacuum pump 212. The moisture trap 218 may comprise one or more filters (such as desiccant filters) and/or a cold trap in various embodiments. Valves 220 and 222 serve to isolate the moisture trap 218 and/or the vacuum pump 212. Valve 224 opens the unit 200 up to atmosphere so that lid 208 may be lifted and dry samples 202 may be removed.

A sensor 226 to detect dryness, such as one or more of a pressure sensor, a capacitance sensor, or an impedance sensor is provided. At least one sensor 228 is provided to monitor the temperature of samples 202 (e.g., by measuring infrared radiation). The sensor 226 and/or the sensor 228 may be used to determine when the samples 202 are dry. Control electronics 230 are provided including at least one controller 232 to automatically control the various components for the drying process. The controller 232 may receive signals from the sensors 226, 228 and determine when the sample(s) 202 are sufficiently dry. The control electronics 230 may also include a user-accessible display 234 and user interface inputs and outputs 236.

The unit 200 can include at least one evaporator plate 238 in the cavity 206. As illustrated, the unit 200 includes a plurality of spaced-apart evaporator plates 238 that are positioned to underlie respective samples 202 such that water is received on or trapped by the evaporator plates 238, as described below. The evaporator plate(s) 238 may comprise one or more of silicon carbide, an active heater element, or a piezoelectric element which provides thermal and/or vibrational energy to quickly evaporate residual water. Other materials and/or components or combination of materials may also be used.

The operation of the unit 200 will now be described with reference to FIGS. 2A and 2B. At least one sample 202 is placed on at least one evaporator plate 238 in the cavity 206 and the lid 208 is closed manually or automatically. Initially, valves 220 and 222 on opposite sides of the moisture trap 218 are open and valve 224 is closed. Vacuum pump 212 is then switched on and a vacuum is applied to the cavity 206 through the moisture trap 218. Initially, when the vacuum is applied, loose water exits pores of the sample(s) 202 and is trapped by evaporator plate(s) 238.

Once the vacuum has reached a predetermined level, uniform electromagnetic energy in the microwave region is directed into the cavity 206 at a prescribed power level using control electronics 230, microwave generator 214 and microwave waveguide 216. During the drying process, the temperature of samples 202 and/or the interior of the cavity 206 is monitored using sensor 228. If the temperature of the samples rises above a defined temperature, the control electronics 230 (e.g., the controller 232) reduces the microwave power produced by microwave generator 214. The control electronics 230 can substantially continually adjust the microwave power level to keep sample(s) 202 and/or the interior of the cavity 206 at or near room temperature. As the drying process continues, the sensor 226 and/or the sensor 228 are used to monitor the dryness in the cavity 206 and may also be used to determine when sample(s) 202 are dry. As noted above, the controller 232 may be configured to receive signals from the sensors 226, 228 and may be configured to determine when the sample(s) 202 are dry based on the received signals.

When sample(s) 202 are dry, vacuum pump 212 may be automatically turned off by control electronics 230 (e.g., by the controller 232) and at least valve 224 (and possibly valve 220 and/or valve 222) is opened to atmosphere (e.g., by the controller 232). The cavity 206 pressurizes to atmospheric pressure. The lid 208 can be opened and dry samples 202 can be removed for testing.

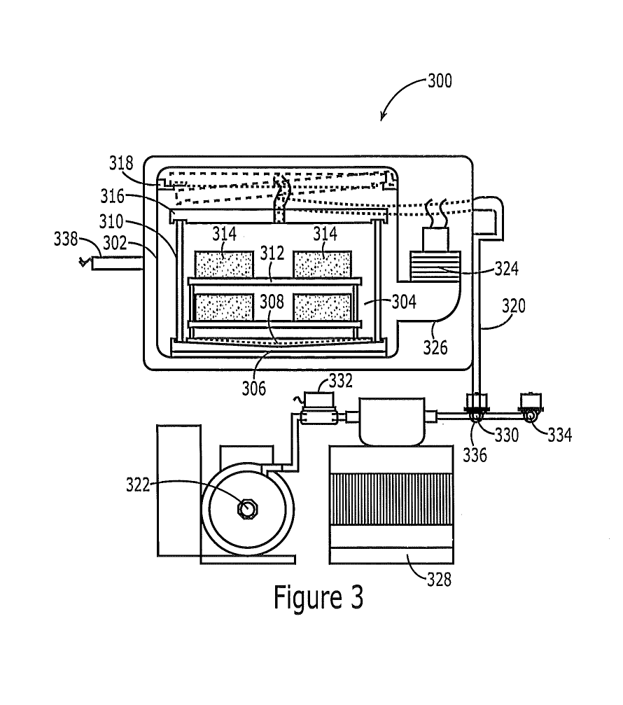

Alternative configurations of drying systems employing vacuum and electromagnetic energy are contemplated. For example, FIG. 3 shows a system 300 wherein the vacuum chamber 304 is held inside the microwave cavity 302. The vacuum chamber 304 includes a bottom 306, which may include thermal energy elements 308, such as silicon carbide heating elements or piezoelectric elements, to provide thermal energy to remove residual water. The vacuum chamber 304 also includes a chamber or vessel wall 310, shelves 312 on which wet samples 314 may be placed, and a top or lid (e.g., top plate) 316. The bottom 306, wall 310 and top 316 form a sealed vacuum chamber or vessel when in use. The lid 316 can rest on one or more ledges or shelves 318 in the microwave when not in use.

In use, the lid or top 316 can translate or move down to seal the top portion of the vacuum chamber 304. Tube 320 extends through a microwave enclosure and to the microwave cavity 302 and is connected to the top 316. A vacuum is obtained when the top or lid 316 is placed on the vacuum chamber wall 310 and a vacuum pump 322 engaged. Electronics including at least one controller (not shown) are used to control the power output from microwave generator 324 which is directed into waveguide 326 and electromagnetic waves enter the cavity 302. Outside the microwave cavity 302 are the vacuum pump 322, a moisture trap 328, valves 330 and 332 that isolate the moisture trap 328 and/or the vacuum pump 322, and an inlet valve 334. Sensor 336 monitors at least one condition, such as pressure, in the vacuum chamber 304. Sensor 338 can be a near infrared sensor to measure infrared radiation in the vacuum chamber 304 and/or the microwave cavity 302. Multiple sensors may be used to provide more accurate infrared radiation or temperature sensing.

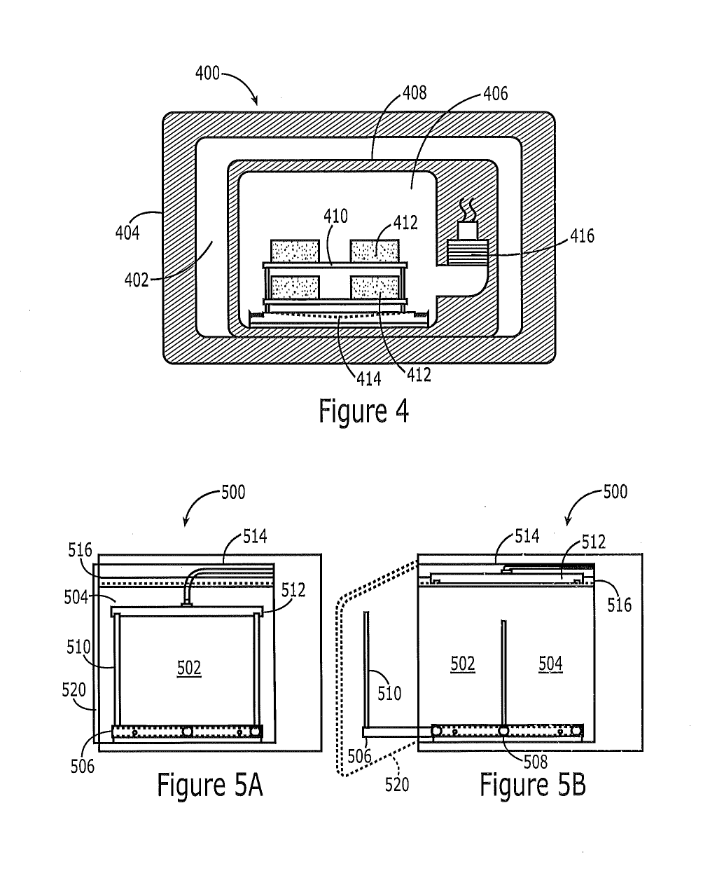

FIG. 4 shows another embodiment for obtaining vacuum conditions for electromagnetic energy drying. The drying system 400 includes an outer chamber 402 defined by enclosure 404 and an inner chamber 406 defined by enclosure 408. One or more trays 410 are provided within the inner chamber 406, with each tray 410 configured to hold one or more samples 412 thereon. Thermal energy elements 414 may be provided below the trays 410 to facilitate evaporation of water from the samples 412. An electromagnetic energy generator 416 supplies electromagnetic energy to the inner chamber 406. The inner chamber 406 defines an electromagnetic cavity that is in fluid communication with the outer chamber 402 such that whatever pressure is in the outer chamber 402 the inner chamber 406 experiences the same or substantially the same pressure. For example, in some embodiments, the enclosure 408 may include apertures such that vacuum applied to the outer chamber 402 is also applied to the inner chamber 406. As vacuum is pulled on outer chamber 402, a vacuum is also pulled on inner chamber or electromagnetic cavity 406. One skilled in the art will recognize that any sensing or detection carried out in the previously and later-described embodiments may also apply to this embodiment.

The drying system 500 illustrated in FIGS. 5A and 5B adds the capability to easily slide a specimen container or holder 502 out of an electromagnetic cavity 504. As illustrated, the specimen container 502 is on a platform 506 which is attached to slide 508. Platform 506 extends, slides or translates outside of electromagnetic cavity 504 for easy access to samples. A door 520 may be moved from a closed position (FIG. 5A) to an open position (FIG. 5B). As shown in FIG. 5B, specimen containment lid 512 may be removed and placed on lid support 516 or just held suspended. Once the specimen containment lid 512 is removed the specimen container 502 may be pulled out of the electromagnetic cavity 504 (e.g., by pulling on specimen container enclosure or wall 510). It will be recognized that any sensing or detection described in connection with the previously and later-described embodiments may also apply to this embodiment. In addition, it will be recognized that there are other ways in which a sliding containment system could be implemented such as other slides, tracks, rollers, belts, chains and the like.

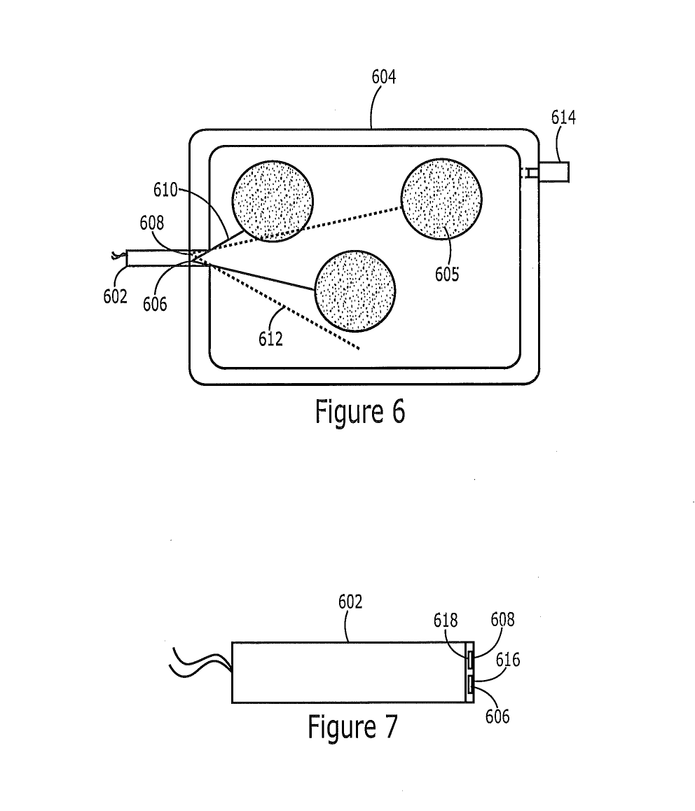

Devices and methods for temperature sensing suitable for any of the infrared or temperature sensors described with respect to the above embodiments are illustrated in FIG. 6. A non-contact infrared temperature sensor 602 includes at least two IR (infrared radiation) detection channels, shown as channel 1 606 and channel 2 608. The field of view of IR channel 1 606 is indicated by line 610 and the field of view of IR channel 2 608 is indicated by line 612. Channel 1 606 and Channel 2 608 are configured to measure different regions of the IR spectrum. In addition, the infrared temperature sensor 602 may be combined with pressure sensor 614 to enhance detection of a sample dry state. Pressure sensor 614 will detect a significant pressure drop when water has been removed from samples 605. It will be understood that the temperature sensor 602 and/or the pressure sensor 614 may be used in any of the drying systems and units described above. For example, the temperature sensor 602 may be used in place of the sensor 228 and/or the pressure sensor 614 may be used in place of the sensor 226 as described above in connection with the system 100 (FIGS. 2A and 2B).

The sensor 602 is shown in greater detail in FIG. 7. As illustrated, IR channel 1 606 incorporates a filter 616 to transmit only part of the infrared spectrum to channel 1 606. Also as illustrated, IR channel 2 608 incorporates a different filter 618 and transmits a different part of the infrared spectrum to channel 2 608.

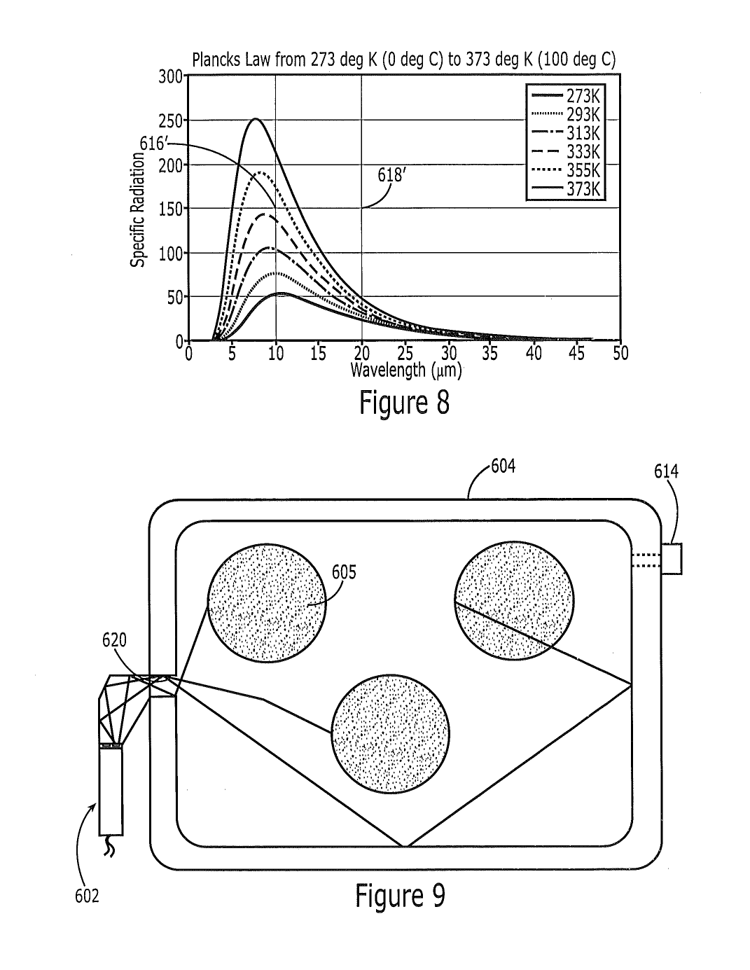

FIG. 8 shows the specific radiation as a function of the wavelength in micrometers for temperatures under consideration. The filters 616, 618 (FIG. 7) may be selected such that each transmits IR wavelengths less than a different upper threshold. For example, the filter 616 may be selected such that it transmits IR wavelengths less than 10 micrometers (616′) and filter 618 may be selected such that it transmits IR wavelengths less than 20 micrometers (618′). This allows a ratio to be calculated which may lead to more accurate temperature estimation. For example, the radiance 618′ detected with IR channel 2 608 and filter 618 may be divided by the radiance 616′ detected with IR channel 1 606 and filter 616.

Those skilled in the art will understand that a single channel IR temperature sensor may also be used to monitor the temperature of the samples. In addition, other geometries may be used where the IR temperature sensor is moved away from direct view of the samples (for example, if the sensor is only exposed to IR radiation escaping from an orifice 620 in the cavity 604 as exemplified in FIG. 9).

Thus, embodiments of the invention are directed to apparatus, methods and systems for rapid drying of loose and compacted samples of materials using a vacuum pump in conjunction with electromagnetic energy such as microwave or infrared to heat the samples and/or the vacuum cavity/chamber. Embodiments of the invention use an innovative infrared temperature sensing of the chamber to monitor sample dry status and determine when the samples are dry. Pressure sensing may also be employed for the monitoring and determination of the dryness of samples. In some embodiments, residual water in the chamber is removed by employing an embedded heating grid in a material that is suitable for microwave exposure and will absorb microwave energy and heat (such as a plastic disc or a silicon carbide disc). One important benefit of electromagnetic energy is that the energy can be distributed more uniformly over the entire chamber area for heating one or multiple samples. This allows for more thorough energy transfer to the water on and in the sample, which increases the water removal rate from the sample and the speed of drying.

Using electromagnetic energy such as microwave energy to heat the samples solves the problem of obtaining reasonably uniform heating supplying energy for evaporation. However, the process of measuring the temperature of the samples becomes increasingly difficult. For microwave radiation, infrared temperature sensors, such as the dual channel detector depicted in FIGS. 6 and 7, are preferred. It is noted from FIG. 6 that the collimation of the radiation detector can be configured to as to not intercept radiation from a single sample but to intercept background infrared radiation emitted from all samples.

All material substances emit radiation, but the radiance of this radiation at a specific wavelength depends on the temperature of the material substance. FIG. 8 shows the spectral radiance as a function of the wavelength at different temperatures. By looking at this graph, in order to obtain temperature, one solution would be to measure the integrated intensity of the spectrum. However the total radiance will depend on the number of samples and the temperature of the samples. If the detector is collimated to a specific location on a specific sample some of the uncertainty can be eliminated.

FIG. 8 illustrates that the peak shifts to the left as the temperature increases. This means that more of the curve area relative to the total area is in the smaller wavelengths. Detection of thermal radiation is aimed at detecting the saturation thermal radiation and looking at the relative radiation with a wavelength below a specified cutoff and comparing it to the radiation below another specified cutoff. FIG. 6 shows the sensor looking at the samples in general, and not at one particular sample. Temperature sensing could also be accomplished by setting the sensor at an oblique angle and detecting what infrared radiation comes out of the orifice as shown in FIG. 9.

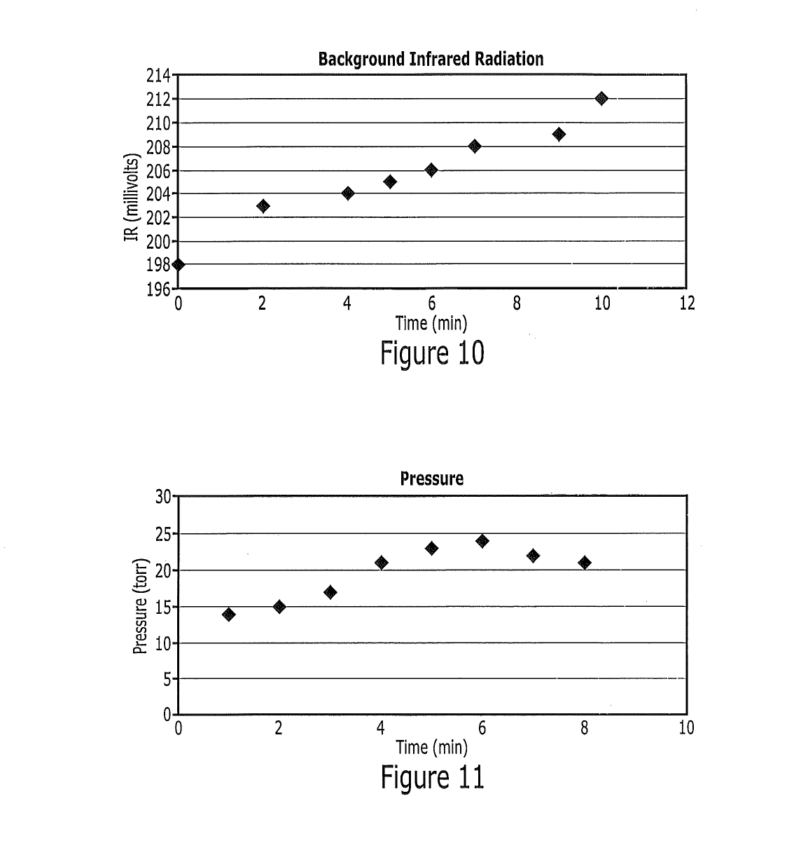

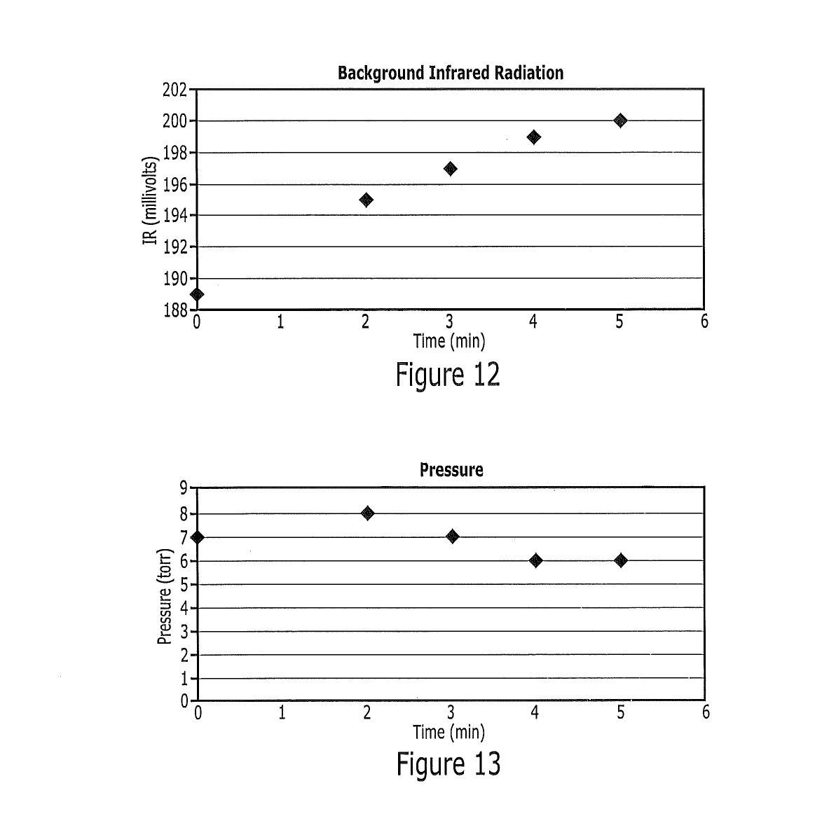

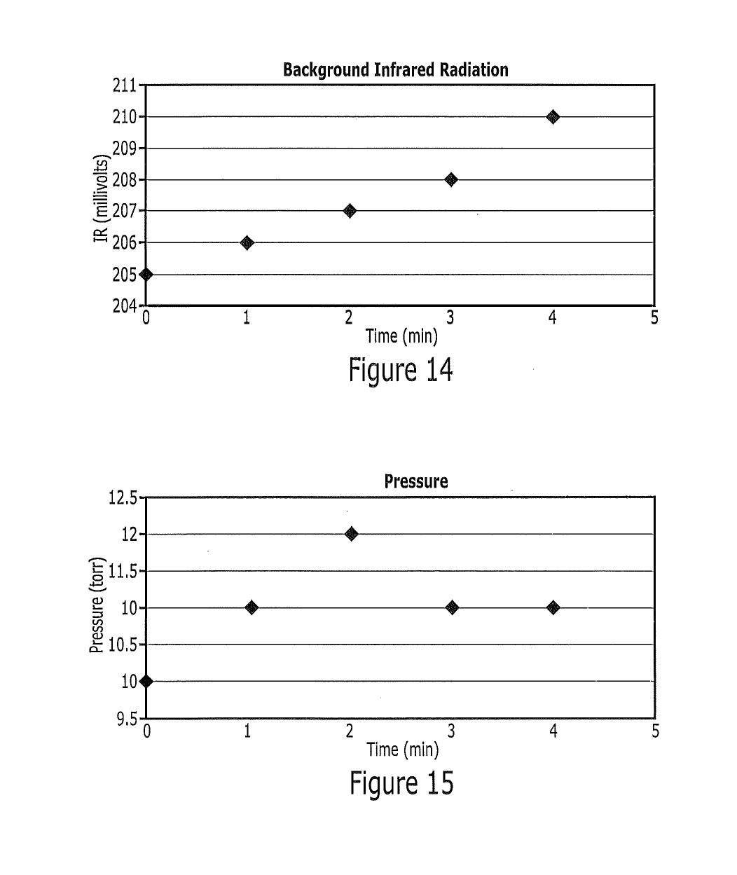

Testing has been performed that indicates considerably faster drying using embodiments of the present invention than with existing drying systems and techniques. FIGS. 10 and 11 illustrate detected infrared radiation over time and detected pressure over time, respectively, for a sample having about 38 grams of water that was dried by applying vacuum and electromagnetic (microwave) energy. FIGS. 12 and 13 illustrate measured infrared radiation over time and measured pressure over time, respectively, for a sample having about 2.8 grams of water that was dried by applying vacuum and electromagnetic (microwave) energy. FIGS. 14 and 15 illustrate detected infrared radiation over time and detected pressure over time, respectively, for a sample having about 9.8 grams of water that was dried by applying vacuum and electromagnetic (microwave) energy.

With reference to FIGS. 10-15, the process of detecting the dry state of a porous sample may be ascertained by noting the behavior of the background infrared radiation in the microwave cavity as indicated by infrared sensors and at the same time noting the behavior of the pressure in the vacuum drying chamber inside the microwave cavity. When the vacuum is initially applied, loose water in the pores of the sample is immediately ejected as air in the pores at ambient pressure trapped by water expands. This ejected water makes its way to the bottom of the microwave vacuum chamber and will slowly continue to evaporate resulting in some background minimum pressure dependent on the amount of water initially in the sample pores. As additional energy is imparted to the sample both the sample and water in the sample begin to heat up. However, as the water absorbs energy, both from the microwave energy and the heat energy in the sample, it begins to evaporate taking much of the heat energy away from the sample. This results in an increase in pressure within the vacuum chamber and either a very slow to virtually nonexistent temperature rise in the sample. The total pressure in the chamber is then the addition of the partial pressure from the evaporating water at the bottom of the vacuum chamber and the partial pressure from the water evaporating from the sample. When the water has completely evaporated from the sample, the sample is no longer cooled by the evaporating water and begins to heat up much more rapidly. In addition, as the dry state is reached there is less evaporation of the water in the sample and therefore less contribution to the partial pressure in the vacuum chamber and the pressure begins to drop. It is the combination of these two physical measurements that indicate a dry sample: increasing background infrared radiation and decreasing pressure in the vacuum chamber.

Therefore, in the experiment illustrated in FIGS. 10 and 11, the sample may be determined to be dry at or just after the six minute mark (i.e., as the pressure begins to drop while the infrared radiation continues to rise). It is noted that a similar core (test sample) took between 30 and 35 minutes to dry in an existing vacuum-drying system.

Similarly, it can be seen from FIGS. 12 and 13 that the sample may be determined to be dry at or shortly after the two minute mark. Likewise, it can be seen from the data of FIGS. 14 and 15 that the sample is dry at or shortly after the two minute mark.

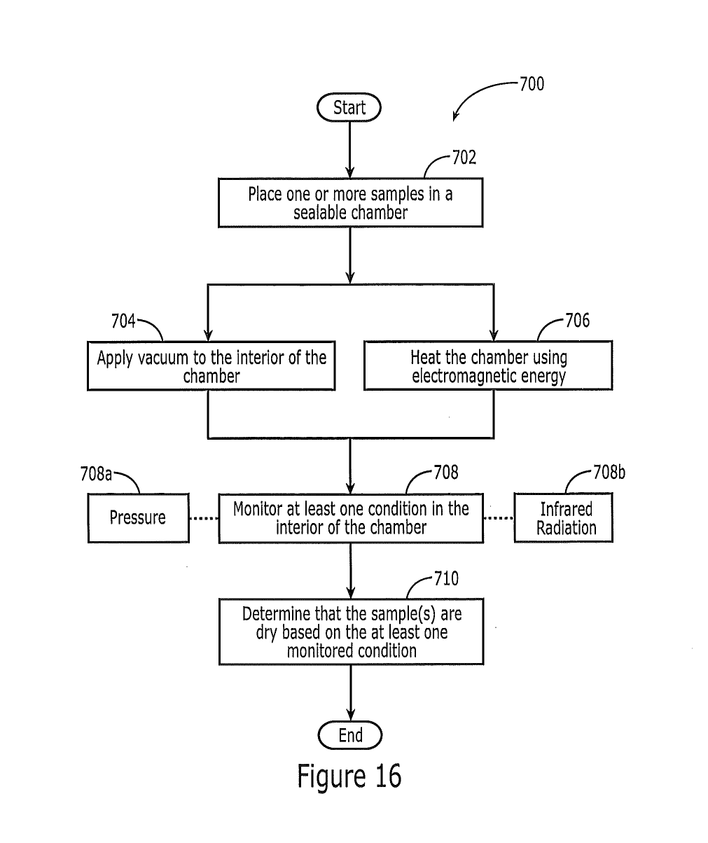

Turning now to FIG. 16, an exemplary operation 700 according to embodiments of the invention is illustrated. One or more samples are placed in a sealable chamber (Block 702). Vacuum is applied to the interior of the chamber (Block 704). While the vacuum is being applied, the chamber is heated using electromagnetic energy (Block 706). At least one condition is monitored in the interior of the chamber (Block 708). In some embodiments, the at least one condition is pressure (Block 708a). In some embodiments, the at least one condition is infrared radiation (Block 708b). In some embodiments, both pressure and infrared radiation is monitored. The samples are determined to be dry based on the at least one monitored condition (Block 710).

It is noted that, due to better distribution of electromagnetic energy throughout, across the surface and/or into the interior of one or multiple samples, rate of water loss from the sample can be considerably higher than that observed with other drying/heating techniques. This means that multiple samples can be dried at one time in approximately the same amount of time as one sample.

Although some of the above discussion focuses on heating by microwave energy/radiation, other forms of electromagnetic energy/radiation, such as infrared energy/radiation, are contemplated for heating the chamber and/or sample(s) held therein.

It will be understood that one or more of the components or features of any of the embodiments described above may be combined.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

That which is claimed is:

1. A method for drying at least one sample of material, the method comprising:
placing the at least one sample of material into an interior of a sealable chamber;
sealing the chamber;
applying a vacuum to the interior of the chamber;
heating the at least one sample using electromagnetic energy while applying the vacuum to the interior of the chamber;
electronically monitoring at least one condition in the interior of the chamber; and
determining that the at least one sample is dry based on the at least one monitored condition.

2. The method of claim 1, comprising heating the at least one sample using microwave energy and a waveguide so as electromagnetic waves cover all sides of a respective sample in the sealed chamber.

3. The method of claim 1, wherein the heating is carried out to maintain the at least one sample and/or the interior of the chamber at a substantially constant temperature.

4. The method of claim 3, wherein the constant temperature is about room temperature.

5. The method of claim 1, wherein the heating is carried out by automatically adjusting the electromagnetic energy delivered or output to maintain the at least one sample and/or the interior of the chamber at a substantially constant temperature.

6. The method of claim 1, comprising filtering moisture from air evacuated from the chamber during at least a portion of the applying the vacuum.

7. The method of claim 1, wherein the at least one sample of material is at least one compacted asphalt sample.

8. The method of claim 1, wherein the at least one sample of material is at least one loose asphalt mix or loose aggregate.

9. The method of claim 1, wherein the at least one sample of material comprises a plurality of samples of material.

10. The method of claim 1, wherein monitoring the at least one condition comprises monitoring pressure of the sealed chamber.

11. The method of claim 10, wherein the monitoring the at least one condition comprises monitoring infrared radiation.

12. The method of claim 11, wherein determining that the at least one sample is dry based on the at least one monitored condition is based on a rise in the monitored infrared radiation and a corresponding substantially concurrent drop in the monitored pressure.

13. The method of claim 12, comprising filtering the infrared radiation below a first predetermined wavelength.

14. The method of claim 12, comprising filtering the infrared radiation below first and second predetermined wavelengths.

15. The method of claim 1, comprising collecting residual water on a thermal energy element under a respective sample in the sealed chamber and evaporating the residual water during the heating step.

16. A system for drying at least one sample of material, the system comprising:
a sealable chamber including an interior sized and configured to house the at least one sample of material, the chamber including an outlet;
a vacuum pump in fluid communication with the chamber to evacuate air from the interior of the chamber through the outlet of the chamber;
an electromagnetic energy source in communication with the chamber; and
at least one controller configured to:
operate the vacuum pump and the electromagnetic energy source;
start and stop a drying operation using the vacuum pump and the electromagnetic energy source;
monitor pressure and infrared radiation in interior of the chamber; and
determine that the at least one sample of material is dry based on the monitored pressure and infrared radiation.

17. The system of claim 16, further comprising a first valve positioned between the vacuum pump and the chamber and a second valve in fluid communication with the chamber and configured to introduce atmospheric air to the interior of the chamber when open, wherein the controller is configured to open and close the first and second valves.

18. The system of claim 17, wherein, during the drying operation:
the vacuum pump is on;
the first valve is open;
the second valve is closed; and
the electromagnetic energy source is operated to maintain the interior of the chamber at about room temperature.

19. The system of claim 18, further comprising a lid for sealably closing the chamber during the drying operation, wherein the first valve is closed and the second valve is open after the drying operation to allow the lid to be removed and the at least one dry sample to be accessed.

20. The system of claim 16, further comprising a moisture trap positioned between the vacuum pump and the chamber to filter moisture from the evacuated air during the drying operation.

21. The system of claim 16, further comprising at least one evaporator plate positioned below the at least one sample and configured to provide thermal energy to evaporate residual water within the chamber during the drying operation.

22. The system of claim 16, further comprising a pressure sensor configured to detect the pressure inside the chamber and an infrared radiation sensor configured to detect the infrared radiation inside the chamber.

23. The system of claim 22, wherein the infrared radiation sensor includes a filter for filtering the infrared radiation below a predetermined wavelength.

24. The system of claim 22, wherein the infrared radiation sensor includes a first filter for filtering the infrared radiation below a first predetermined wavelength and a second filter for filtering the infrared radiation below a second predetermined wavelength.

25. The system of claim 16, wherein the at least one controller is configured to determine that the at least one sample of material is dry based on a drop in the monitored pressure and a substantially concurrent corresponding rise in the monitored infrared radiation.

26. A method for drying at least one sample of material, the method comprising:
placing the at least one sample of material into an interior of a sealable chamber;
sealing the chamber;
applying a vacuum to the interior of the chamber;
heating the at least one sample using electromagnetic energy while applying the vacuum to the interior of the chamber;
monitoring pressure and infrared radiation in the interior of the chamber over time; and
determining that the at least one sample is dry based on an increase in the monitored infrared radiation and a substantially concurrent corresponding decrease in the monitored pressure.
